(19) United States
(12) Patent Application Publication
(10) Pub. No.: US 2006/0041438 A1
(43) Pub. Date: Feb. 23, 2006

(54) Bass tracking

(76) Inventors: Gary M. Megson, Fort Smith, AR (US); James Edward Kelly III, Fort Smith, AR (US); Pamela G. Kelly, Fort Smith, AR (US)

Correspondence Address: Pamela G. Kelly, 5500 Painter Lane, Fort Smith, AR, 72903, US

(21) Appl. No.: 10/921,277

(22) Filed: Aug. 19, 2004

(51) Int. Cl. G06Q 99/00; G06Q 30/00

(52) U.S. Cl. 705/1; 705/26

(57) ABSTRACT

Tracking of fish and publishing results on the Internet for the purpose of profit. I. Attach a frequency transmitter to a legal size fish caught by conventional methods. A. A fiberglass transmitter will be attached to the fish via a nylon cord through the gill plates to allow the transmitter to be removed from the fish if caught II. Use a receiver and antenna combination to locate the fish and record the latitude and longitude as well as the weather and lake conditions. III. Update the Web site with the coordinates of the fish, weather and lake conditions. IV. Subscribers may now log onto the Web site to obtain current information.

### BRIEF SUMMARY OF INVENTION

The Tracking of fish and publishing results on the Internet for the purpose of profit.

I. Attach a frequency transmitter to a legal size fish caught by conventional Methods.
A. Transmitters will be attached via a cord run through the gill-plates.
B. The transmitters will be attached to the fish via a nylon cord to allow the Transmitter to be removed from the fish if caught.
II. Use a receiver and antenna combination to locate the fish location and record The Latitude and Longitude as well as the weather and lake conditions.
III. Update the Web site with the coordinates of the fish and the weather and lake conditions at the home office.
V. Customers may now log on to the Web site to obtain the information.

### BACKGROUND OF INVENTION

Scientists have been using radio telemetry transmitters to follow the movements of fish for years with great success. We plan to use this technology to enhance the knowledge of the average Angler. This will help the average and professional Anglers alike. Most of the professional Anglers use all of the resources available to ensure they have the most up to date data. There are Fishing guides who charge other Anglers for their services and show them where the fish are located. We at Bass Tracking.com will eliminate the need for such things. An Angler can log on to the Internet, retrieve information and learn their habits allowing even an average Angler to compete with the professionals or just catch more fish on the days they fish for pleasure.

1. BassTracking.com claims that to date no other company or organization has used the technology of tracking fish for profit on the Internet. We at Bass Tracking.com also claim that no other company or organization has used such information for other than scientific research or personal use.
BassTracking.com claims the right to patent the process of tracking fish and publishing data on the Internet for the purpose of profit.
